(19) United States
(12) Patent Application Publication
(10) Pub. No.: US 2014/0095059 A1
(43) Pub. Date: Apr. 3, 2014

(54) METHOD TO DETERMINE TRAFFIC CHARACTERISTICS IN ROAD TRAFFIC

(71) Applicant: Skobbler GmbH, Berlin (DE)

(72) Inventor: Philipp Kandal, Tettnang (DE)

(73) Assignee: Skobbler GmbH, Berlin (DE)

(21) Appl. No.: 14/012,078

(22) Filed: Aug. 28, 2013

(30) Foreign Application Priority Data
Sep. 28, 2012 (EP) 12186540.6-2215

(51) Int. Cl. G08G 1/00

(52) U.S. Cl. CPC G08G 1/00
USPC 701/119

(57) ABSTRACT

A method for determining road traffic characteristics utilizing movement data of vehicles which have communication devices trackable by radio positioning. The data includes time and place data regarding acceleration and braking maneuvers recorded by the communication devices. Chronological progression of acceleration and braking maneuvers is evaluated with respect to the occurrence of a predetermined characteristic pattern for a specific traffic characteristic. When such a pattern is detected and is linked to the location at which the maneuvers took place, this location is determined to be the location of the traffic characteristic. A report regarding the characteristic and its location is submitted to a central data collection point. In the central data collection point, the reports are evaluated. When a threshold number of similar reports from various users regarding the traffic characteristic at a certain location is exceeded, then this characteristic is classified as being reliably determined at the corresponding location.

### TECHNICAL FIELD

The present invention relates to a method for detecting traffic characteristics in road traffic.

Road traffic, which to a great extent represents a dynamic and complex system, is becoming increasingly more about the traffic characteristics that occur at particular locations and over certain timeframes and also includes events that are set up for the long-term.

Such types of traffic characteristics include lane bottlenecks, objects lying on the roadway, accidents, construction sites, traffic lights, as well as stationary or mobile speed monitoring devices set up on the roads by the authorities.

It is not merely for reasons of providing information to road users, but also for considerations influencing route considerations for the individual road users and thus for fulfilling traffic routing and guidance functions, it should be ensured that information on traffic characteristics be provided to vehicle drivers in the most extensive, quick, and precise manner possible. Thus, for many years, it has been possible for road users to receive traffic updates via broadcasting transmissions on their car radios. It has also been possible to receive traffic reports via the Internet for quite a while now.

Traffic reports that are broadcast over radio stations are meanwhile not only being broadcast as voice messages but also in an encoded format, e.g. via the so-called TMC system, wherein these traffic reports, transmitted in an encoded format are receivable and readable by navigation devices set up with navigation and route guidance, equipped with the corresponding receivers, so that road users that use such navigation devices can stay informed of traffic characteristics along their route and be warned of these accordingly and/or route planning can be carried out by the route planning routine in the navigation device while considering traffic characteristics, e.g. by bypassing existing road closures or sections of roads with other traffic obstructions. Navigation devices in this case are understood to be not only those devices that are permanently installed in motor vehicles but also those mobile devices that are designed for this purpose. Navigation devices in terms of this invention are particularly also mobile telephones, smart phones, tablet PCs, or other digital end units that have positioning technology, particularly a GPS receiver, and in which navigation software is installed and running.

Furthermore, users of certain navigation systems today are additionally informed by the services provided by the navigation providers regarding traffic characteristics such as, for example, where speed monitoring devices are set up and regarding sections of roads with certain speed limits. Thus, there are, for example, regular updates to the navigation software, wherein a transfer of the data sets, in which particular stationary traffic characteristics such as permanently set up speed monitoring devices in localities or at other traffic route points, is entered and updated. The applicable speed limit or permissible maximum speed for the respective location of the speed monitoring device can also be attached to this data. Other traffic reports also are not only provided to road users by the “authorities”; in this case as well, there are parallel systems of navigation providers that provide information obtained from user data back to their users regarding traffic characteristics.

In order for the corresponding information regarding traffic characteristics to be broadcast and transferred to the road users, however, it must first be obtained. This is done in very different ways. It has been common knowledge for quite a while now that traffic can be monitored, for example, from the air, during which the police use traffic-monitoring helicopters or comparable aircraft to fly over problematic sections of roads or primary road connections such as interstates and monitor the occurrence of traffic characteristics such as accidents, stranded vehicles, and other obstructions and then report these traffic characteristics to a central division from where they are then broadcast. Another known method is the use of camera monitoring systems set up at particularly problematic points on roads; the image data from these cameras are monitored at central monitoring stations and when certain traffic characteristics such as traffic obstructions or the like occur, a corresponding message is generated. Another known method is to incorporate the road users themselves into the recording of traffic characteristics. Thus, there are particular traffic reporting telephone lines with which road users who have seen traffic characteristics, such as a stranded vehicle or an accident, can report them by telephone and report the type and location of the traffic characteristic observed.

Furthermore, there are systems known with which road users can report particular traffic characteristics to a central office by data entry into their navigation device, for example by pressing a button. The corresponding input is then reported by a communication unit of the navigation device to a central data collection point and processed there. These types of procedures are described, for example, in DE 10 2006 010572 A1 and with reference to particular speed monitoring systems in U.S. Pat. No. 6,675,085, as well as in WO 00/29869 A1. In addition, WO 00/29869 A1 describes another option for reporting a traffic characteristic in the form of a speed monitoring system. Accordingly, by using devices equipped with communication equipment that can automatically detect radar being generated by, for example, speed monitoring systems, an automatic report of such a system and its location can be reported to a central collecting point without the driver of the vehicle having to undertake any action.

A problem with respect to the known options and methods of determining traffic characteristics is, on one hand, the significant complexity (installation of camera systems, executing monitoring flights) that can really only be carried out for certain road sections of a highway and route system and, on the other hand, the low percentage of road users who actually report traffic characteristics. Evaluations of data and statistics have shown that only one to about two percent of users of navigation devices that have a reporting function for reporting traffic characteristics, in this case specifically speed monitoring systems, actually use the option of making a report. The data submitted to the data collection points in this manner, and that is available as information for road users, is thus extremely fragmented.

The option described in WO 00/29869 A1 of automated reporting upon detection of a speed monitoring system based on the radar radiation generated by the system and registered by the detector in the vehicle is also only suitable to a limited extent for reliably increasing the data density. The reason is that many modern speed monitoring systems can no longer be detected with the known detectors, and in addition, only a few drivers even use the corresponding detectors anymore. Moreover, this type of information obtainment is limited to speed monitoring systems; it cannot be used for other traffic characteristics such as traffic obstructions, traffic lights, and the like.

The object of the invention is thus to provide a method for determining traffic characteristics in road traffic that will enable the determination of traffic characteristics without high expense and in a reliable manner and will do so in the most automated manner possible and with a great amount of data density.

### SUMMARY

This objective is achieved by a method of traffic characteristics in road traffic from the movement data of vehicles driven by drivers using communication devices trackable by means of radio positioning, particularly satellite radio positioning, wherein
i) time and place data regarding acceleration and braking maneuvers for the respectively assigned vehicles are recorded by means of communication devices;
ii) the chronological progression of acceleration and braking maneuvers of a vehicle with respect to the occurrence of a predetermined characteristic pattern for a specific traffic characteristic is evaluated;
iii) when a predetermined characteristic pattern for a specific traffic characteristic is detected and is linked to the location at which the corresponding acceleration and/or braking maneuvers took place, this location is determined to be the location of the traffic characteristic and a report regarding the type of traffic characteristic and its location is submitted to a central data collection point; and
iv) in the central data collection point, the reports being received are evaluated and when a threshold number of similar reports from various users regarding a certain type of traffic characteristic at a certain location is exceeded, then this traffic characteristic is classified as being reliably determined at the corresponding location.

Advantageous further embodiments of the method include a method in which in Step ii), an evaluation occurs regarding the occurrence of a predetermined characteristic pattern, at least in the braking maneuvers, for a specific traffic characteristic. Still further, the evaluation occurs in the communication device. The method is further characterized in that the communication devices transfer the data recorded in Step i) to a central evaluation point, at which the evaluation according to Step ii) occurs.

Furthermore, during the determination of a traffic characteristic, the speed at which a vehicle moves, in which the communication device is being used, before a braking or acceleration maneuver, is also included and, particularly, a report according to Step iii) does not occur unless said speed exceeds a specified threshold. In the method the recording of the data also includes the time in Step i) and, in addition to the location, the time of the determination of a traffic characteristic is reported to the central data collection point in Step iii).

A traffic characteristic determined once in accordance with Step iv) is discarded as being no longer in existence if there are no further confirmed reports of the determined traffic characteristic being received at the central data collection point in a predetermined timeframe.

In the method, movement data is determined from the chronological pattern of the location positions of the communication devices determined via radio positioning. Movement data regarding the acceleration and braking maneuvers is determined by acceleration sensors integrated in the communication device or connected to said device using signal technology. When a predetermined characteristic pattern for a specific traffic characteristic is detected in the chronological pattern of the acceleration and/or braking maneuvers, the type of traffic characteristic assumed, based on the pattern, is indicated to the driver by the communication device and once this is confirmed, the information is transmitted to the central data collection point.

In a further aspect, this objective is achieved by means of a traffic guidance system which has the following:
i) a plurality of communication devices set up for radio positioning and for route guidance that are used individually in a vehicle to which they are allocated;
ii) a central data collection point that is set up for receiving data transmitted by means of the communication devices;
iii) a data transmitter that is connected to the data collection point and is set up to transmit traffic guidance data to the communication devices; wherein the communication devices are set up to record time and location data regarding acceleration and braking maneuvers for the respective vehicle to which they are assigned, wherein the communication devices are set up to evaluate the recorded data with respect to the occurrence of a predetermined characteristic pattern in the braking and/or acceleration maneuvers for a specific traffic characteristic and for determining such a traffic characteristic, wherein the communication devices are set up to transfer signals representing a certain traffic characteristic and the location of its occurrence to the central data collection point, wherein the data collection point is set up to evaluate a certain traffic characteristic as being reliably determined when the data transferred by a predetermined number of communication devices enable the detection of a similar traffic characteristic at a location, and wherein the data transmitter is set up to transmit information to the communication devices regarding the type and location of the traffic characteristic determined to be reliable as traffic data.

The inventors have determined that the acceleration and braking maneuvers of vehicles that are undertaken by their drivers due to various traffic situations can vary significantly in their respective patterns and chronological progressions. They have further determined that the patterns of acceleration and/or braking maneuvers can be used to draw conclusions about the occurrence of a corresponding driving behavior by the driver, particularly with respect to certain traffic characteristics according to their type. Thus, there is a general difference (regardless of the respective drivers) between a braking maneuver when approaching a traffic light and, for example, a braking maneuver that is executed due to an obstacle that suddenly occurs. Even braking and acceleration maneuvers that drivers carry out when they recognize a speed monitoring system while driving quickly, when they subjectively perceive themselves to be driving too quickly early enough, or when they are recorded by such a type of speed monitoring device and have determined that they have been photographed through the transmission of a camera flash, have a certain pattern. In these cases, drivers brake very abruptly in order to reduce their speed well before the speed monitoring system or they do so as a shocked reaction to the flash after the measurement is triggered but then normally accelerate briefly back to a higher speed after the speed monitoring system has been left behind. Thus, there is a brief sequence of a characteristic abrupt braking maneuver with a subsequent acceleration phase.

The idea and the core concept of the invention is to record the acceleration and braking maneuvers that are executed by the driver of the vehicle carrying the communication device using a communication device, as used by many drivers today, e.g. in the form of a navigation device with communication functions either via radio networks or via the Internet or even in the form of a smart phone, mobile telephone, or via computers such as, for example, a tablet PC, trackable via satellite radio positioning, and to analyze this data in order to detect characteristic patterns in these acceleration and/or braking maneuvers for certain traffic characteristics and to draw conclusions about the presence of a traffic characteristic of a specific type at the location where the maneuver took place. This data and the reported traffic characteristics are initially recorded in a central data collection point that every communication device will be connected to. Reports regarding traffic characteristics are compiled in the central data collection point and then, when a certain number or a target threshold has been reached or exceeded, this traffic characteristic is reliably determined to exist at the corresponding location. The analysis of braking and/or acceleration maneuvers can take place based on immediate measurement of acceleration and/or braking values or even directly via an evaluation of the chronological pattern of speed determinations carried out.

In this manner, fully automated data from a plurality of users of accordingly set up communication devices (on which, for example, corresponding software is installed and running) is thus collected, and a statistical assessment takes place in this regard, as only those traffic characteristics will be determined as reliably detected, for which there are a minimum number of matching reports at the data collection point regarding traffic characteristics from drivers using communication devices, generated by means of braking and/or acceleration maneuvers. Currently, the inventors are assuming that a matching report of a certain traffic characteristic by 10 to 15 independent users or communication devices will ensure that such a traffic characteristic is reliably determined. This number may vary, however, if additional verification criteria have been specified; in the most optimum case, the report from a single communication device would be sufficient for a reliable determination.

Especially preferably, the evaluation of the movement data and driving maneuvers is based at least on the characteristic patterns in the braking maneuvers. Because these types of braking maneuvers have a very particular set of characteristics when they involve traffic characteristics such as traffic lights, suddenly occurring hazards, or the like. By evaluating the acceleration maneuvers as well, more precision is achieved and, in particular, speed control points can be detected with greater accuracy and reliability.

Basically, it is possible for the communication devices to transmit all the data recorded by them, with respect to time and place, regarding acceleration and braking maneuvers of the vehicle in which they are being used, to a central evaluation point where the evaluation takes place; the detected traffic characteristics are then forwarded to the central data collection point. However, this type of method is complex and requires extensive central computing capacity. In this respect, it is preferable for the evaluation of the place and time data, regarding acceleration and braking maneuvers of the vehicle in which the communication devices are being used, to take place in the communication devices themselves, and for the data to not be transferred to the central data collection point until, by means of this data and the specific occurring pattern, a certain traffic characteristic is detected, and only then is a corresponding notification regarding the type and place of the traffic characteristic sent to the central data collection point. This reduces the wireless communication to the central data collection point that is typically connected centrally via mobile radio technology or the Internet or other wireless communication paths.

Especially when the method according to the invention involves the detection of speed control sites as the traffic characteristics, the absolute speed driven before a braking maneuver can be included as an additional parameter to be considered. Thus, particularly only braking and subsequent acceleration maneuvers of such vehicles, which were previously driven more quickly than the maximum permissible speed at the site at which the braking maneuver occurred, can be included in the evaluation for a speed monitoring device possibly set up in the section of road in question, wherein, in this case, a threshold value for the minimum amount to be exceeded can also be specified, for example 10%, or an absolute value of 10 km/h for example; any data measured below these values would not be considered. The maximum speed at the respective sections of road can be known to the communication devices as a data set and be directly included in the evaluation. However, such values can also be stored at the central evaluation point and first be included in the evaluation at that point.

It is further advantageous if, as proposed with an advantageous embodiment of the invention, in addition to the place and type of traffic characteristic determined, the time at which it is recorded or observed, i.e. the time at which the corresponding characteristics occurred in the pattern of braking and acceleration maneuvers of the vehicle, is also recorded and included in further data processing. This is because traffic characteristics are frequently temporary in nature. Thus, traffic obstacles appear and then disappear. Speed monitoring systems can be stationary and thus more permanent in nature. Many times however, the authorities will set up mobile speed monitoring systems and operate them for a certain timeframe and then disassemble them after a monitoring period has elapsed. To ensure that traffic characteristics that no longer exist after a certain time period do not continue to be perceived as determined, those traffic characteristics for which further reported corresponding observations, from movement data with acceleration and braking maneuvers from vehicles, no longer exist or are no longer being received at the central data collection point for a certain, defined timeframe are deleted as being no longer in existence.

The determination of movement data, i.e. in this case the acceleration and braking data as well as the absolute speed and/or the corresponding maneuvers, if applicable, and the resulting chronological patterns and sequences, can be obtained, for example, from position changes in the radio-located communication device. In a similar manner, as an alternative or even in addition to this, acceleration or speed sensors can be used that are integrated in the communication device or are connected to it and use signal technology to determine the measured values or measured signals. For example, modern smart phones have integrated acceleration sensors which can be utilized for this. The corresponding utilization of such hardware can be done by programming the software required for the sequence of this method.

In order to reduce the number of reports required for a reliable assumption of a determined traffic characteristic (or even to use a single report as a basis for a reliable report as an option), the method utilized includes when a predetermined characteristic pattern for a specific traffic characteristic is detected in the chronological pattern of the acceleration and/or braking maneuvers, the type of traffic characteristic assumed, based on the pattern, is indicated to the driver by the communication device and once this is confirmed, the information is transmitted to the central data collection point. By means of the user being prompted by the communication device to confirm, or optionally to correct, the detection of the assumed traffic characteristic, based on the automatic evaluation, the information received in this manner can be considered reliable when such a confirmation or correction occurs, or a higher rating can be included in the measurement, so that only a smaller number of control reports of the same content will be required in order for the traffic characteristic to be reliably assumed to exist.

As previously explained, a further component of achieving the objective is a traffic guidance system. Accordingly, such a type of traffic guidance system has a plurality of communication devices set up for radio positioning and for route guidance, e.g. navigation devices that can be located via GPS, whether this be in the form of devices formed separately as navigation devices, whether this be in the form of smart phones, mobile telephones, tablet PCs, or other digital devices equipped with corresponding software, a central data collection point that is set up to receive data transmitted via the communication devices, particularly wirelessly, as well as a data transmitter that is connected to the data collection point and is set up to transmit traffic guidance data to the communication devices. The communication devices for recording time and place data regarding acceleration and braking maneuvers for the respectively assigned vehicle function in the system according to the aforementioned method, and information regarding the presence of certain traffic characteristics, such as traffic jams or speed monitoring systems, is determined from this data accordingly. The information obtained in this manner is then transmitted back to the users of the communication devices via the data transmitter so that this data, for example, can be displayed for the purposes of warnings regarding traffic jams or speed monitoring areas but also can be used for route calculations.

### BRIEF DESCRIPTION OF THE SEVERAL VIEWS OF THE DRAWINGS

The enclosed figures show examples of theoretically determined chronological speed patterns of vehicles as results based the reaction of the drivers to different types of traffic characteristics and as a characteristic pattern upon which the evaluation can be based. The following is shown:

FIG. 1 shows the pattern of speed and acceleration values that are typical for the approach of a vehicle to a construction site;

FIG. 2 shows the pattern of speed and acceleration values that are typical for the approach of a vehicle to a traffic light; and

FIG. 3 shows the pattern of speed and acceleration values that are typical for how a vehicle is driven in the vicinity of a speed monitoring device when the driver detects said speed monitoring system in a manner that is late and surprising.

### DETAILED DESCRIPTION

The three diagrams show graphs of typical driving behaviors of drivers for different traffic characteristics and the application of the progression of driving speed and acceleration (represented on the y-axis in each case) over time (represented on the x-axis). In addition, the values for the speed limits applicable to the respective section of road (the maximum permissible speed) are also entered. The dark-gray lines with the square points represent the current driving speed, the medium-gray lines with the diamond-shaped points represent the maximum permissible speed, and the light-gray lines with the triangle-shaped points show the acceleration values (acceleration or braking).

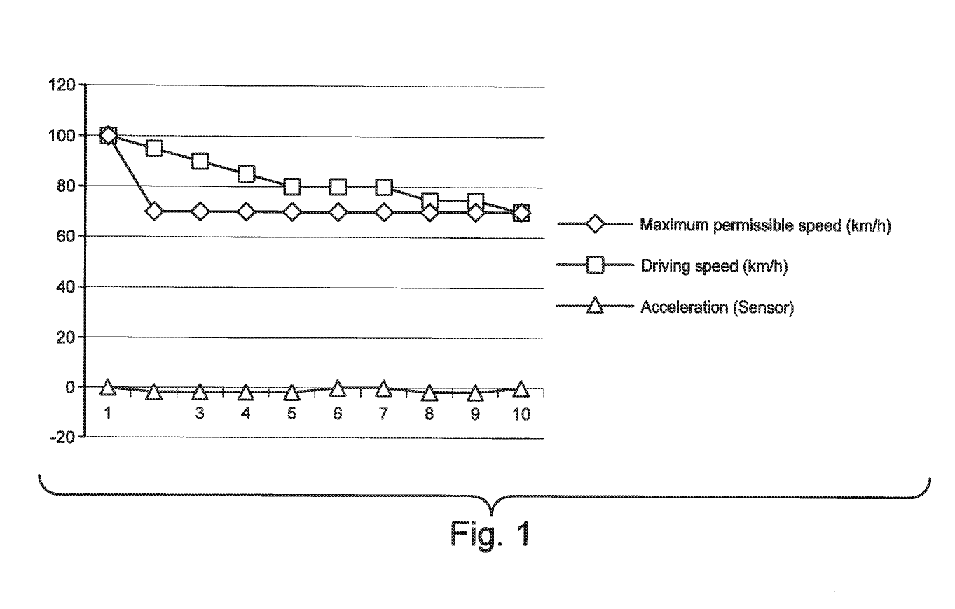

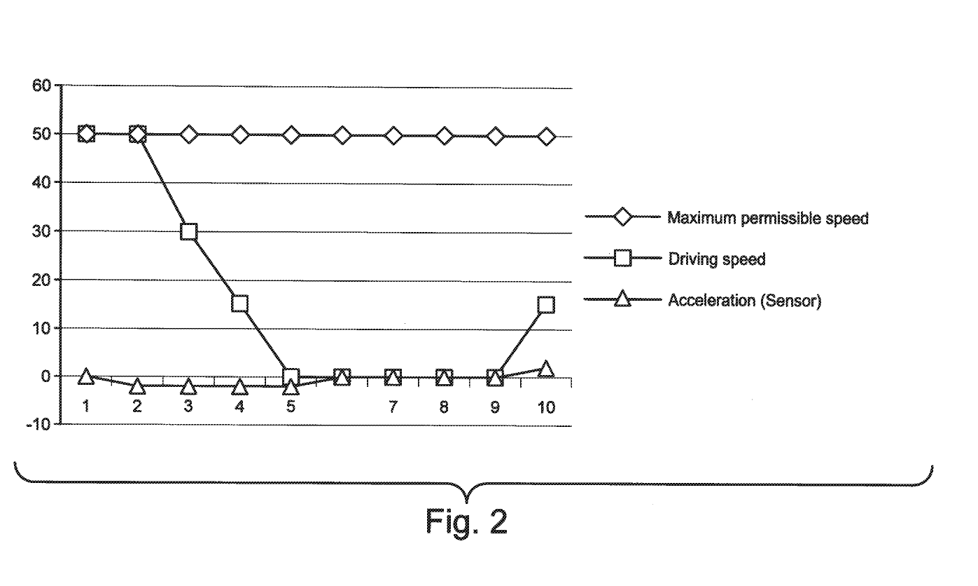

The differing patterns for the cases selected here, involving a construction site (FIG. 1), a traffic light (FIG. 2), and a speed monitoring device (coming as a surprise to the driver), are obvious. While with the construction site (FIG. 1, the case involving a typical interstate construction site lasting a longer period of time, with prior notification), the maximum permissible speed decreases abruptly, the driver of the vehicle typically, however, only slowly reduces the vehicle's speed with slight braking; with a traffic light at which the maximum permissible speed does not change (see FIG. 2), the driver brakes severely until a speed of zero is reached. After the vehicle remains at a standstill for a certain time period, there is fast acceleration.

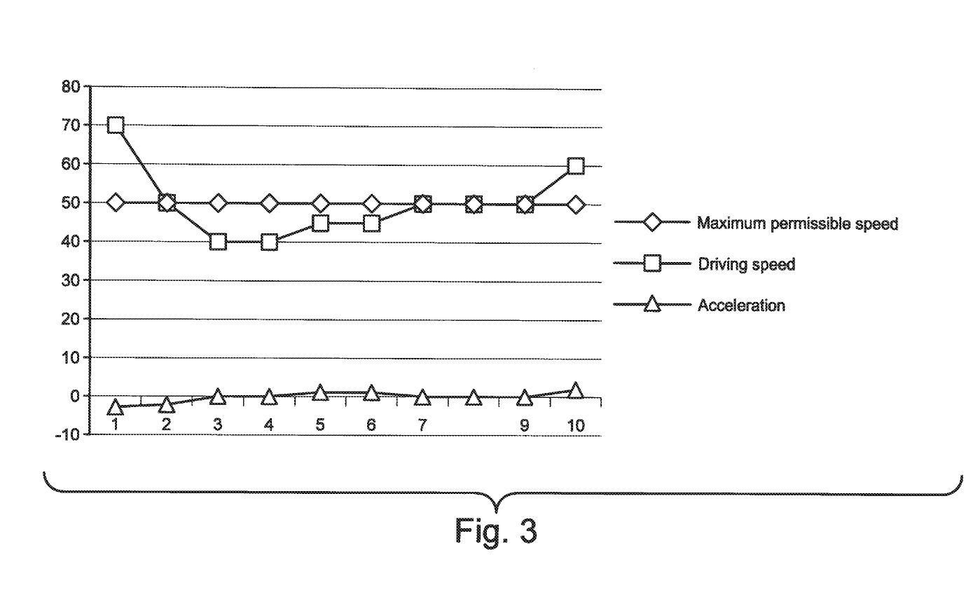

In the case of a speed monitoring device that is detected as a surprise, the driver, particularly if, as shown in FIG. 3, the driver was previously driving faster than the maximum permissible speed, brakes abruptly and slows down to significantly less than the maximum permissible speed and then, after passing the measuring device, re-accelerates significantly, often initially only up to the maximum permissible speed and then goes beyond that speed.

The significantly different patterns allow automated conclusions to be drawn about the respective traffic characteristic when they are evaluated and detected in the aforementioned manner.

1. A method to determine traffic characteristics in road traffic from movement data of vehicles driven by drivers using communication devices trackable by means of radio positioning, particularly satellite radio positioning, wherein
i) time and place data regarding acceleration and braking maneuvers for the vehicles are recorded by means of the communication devices;
ii) a chronological progression of acceleration and braking maneuvers of a specific vehicle with respect to an occurrence of a predetermined characteristic pattern for a specific traffic characteristic is evaluated;
iii) when the predetermined characteristic pattern for the specific traffic characteristic is detected and is linked to a location at which the corresponding acceleration and/or braking maneuvers took place, this location is determined to be the location of the traffic characteristic and a report regarding the specific type of traffic characteristic and its location is submitted to a central data collection point; and
iv) in the central data collection point, the reports being received are evaluated and when a threshold number of similar reports from various users regarding the specific type of traffic characteristic at a certain location is exceeded, then this traffic characteristic is classified as being reliably determined at the corresponding location.

2. The method according to claim 1, wherein, in Step ii), an evaluation occurs regarding the occurrence of the predetermined characteristic pattern, at least in the braking maneuvers, for the specific traffic characteristic.

3. The method according to claim 1 wherein the evaluation according to Step ii) occurs in the communication device.

4. The method according to claim 1 wherein the communication devices transfer the data recorded in Step i) to a central evaluation point, at which the evaluation according to Step ii) occurs.

5. The method according to claim 1, wherein during the determination of the specific traffic characteristic, a speed at which the specific vehicle moves before the braking or acceleration maneuver, is also included and, particularly, the report according to Step iii) does not occur unless said speed exceeds a specified threshold.

6. The method according to claim 1, wherein the recording of the data also includes a time in Step i) and, in addition to the location, the time of the determination of the specific traffic characteristic is reported to the central data collection point in Step iii).

7. The method according to claim 6, wherein the specific traffic characteristic determined once in accordance with Step iv) is discarded as being no longer in existence if there are no further confirmed reports of the specific traffic characteristic being received at the central data collection point in a predetermined timeframe.

8. The method according to claim 1, wherein the movement data is determined from a chronological pattern of location positions of the communication devices determined via radio positioning.

9. The method according to claim 1, wherein the movement data regarding the acceleration and braking maneuvers is determined by acceleration sensors integrated in the communication device or connected to said communication device using signal technology.

10. The method according to claim 1, wherein when the predetermined characteristic pattern for the specific traffic characteristic is detected in the chronological progression of the acceleration and/or braking maneuvers, the type of traffic characteristic assumed, based on the pattern, is indicated to the driver by the communication device and once this is confirmed, the information is transmitted to the central data collection point.

11. A traffic guidance system having the following:
i) a plurality of communication devices set up for radio positioning and for route guidance that are used individually in a vehicle to which they are assigned;
ii) a central data collection point that is set up for receiving data transmitted by means of the communication devices;
iii) a data transmitter that is connected to the data collection point and is set up to transmit traffic guidance data to the communication devices;
wherein the communication devices are set up to record time and location data regarding acceleration and braking maneuvers for the respective vehicle to which they are assigned,
wherein the communication devices are set up to evaluate the recorded data with respect to the occurrence of a predetermined characteristic progression in the braking and/or acceleration maneuvers for a specific traffic characteristic and for determining such a traffic characteristic,
wherein the communication devices are set up to transfer signals representing the specific traffic characteristic and the location of its occurrence to the central data collection point,
wherein the data collection point is set up to evaluate the specific traffic characteristic as being reliably determined when the data transferred by a predetermined number of communication devices enable the detection of a similar traffic characteristic at a location, and
wherein the data transmitter is set up to transmit information to the communication devices regarding the type and location of the specific traffic characteristic determined to be reliable as traffic data.

12. A method to determine a speed monitoring device set up in road traffic from movement data of vehicles driven by drivers using communication devices trackable by means of radio positioning, particularly satellite radio positioning, wherein
i) time and place data are recorded by means of the communication devices regarding acceleration and braking maneuvers of the respective vehicles to which the communication devices are assigned, as well as a speed at which the respective vehicle is moving before and after a braking or acceleration maneuver;
ii) a chronological progression of acceleration and braking maneuvers as well as a driving speed of a specific vehicle with respect to the occurrence of the following characteristic pattern is evaluated:
starting from a first driving speed, a braking maneuver is detected that leads to an abrupt deceleration of the vehicle in which the first driving speed is significantly reduced, followed by an acceleration maneuver until a second driving speed is reached that is less than the first driving speed;
iii) when the characteristic pattern described in ii) is detected, that pattern is linked to a specific location at which the corresponding acceleration and/or braking maneuvers took place, this location is determined to be the location of the traffic characteristic, and a report regarding the type of traffic characteristic and specific location is submitted to a central data collection point; and
iv) at the central data collection point, reports being received are evaluated, and when a threshold number of similar reports are present with the characteristic pattern according to ii) at the specific location is exceeded, then reports of the corresponding location indicating a speed monitoring device set up there are determined to be reliable.

13. The method according to claim 12, wherein the evaluation according to Step ii) occurs in the communication device.

14. The method according to claim 12, wherein the communication devices transfer the data recorded in Step i) to a central evaluation point, where the evaluation according to Step ii) occurs.

15. The method according to claim 12, wherein the report according to Step iii) does not take place until the first driving speed of the vehicle before the braking maneuver in Step ii) exceeds a predefined threshold value.

16. The method according to claim 12, wherein the recording of the data also includes a time in Step i) and, in addition to the location, the time of determination of the traffic characteristic is reported to the central data collection point in Step iii).

17. The method according to claim 16, wherein the speed monitoring device determined once in accordance with Step iv) is discarded as being no longer in existence if there are no further confirmed reports of it being received at the central data collection point in a predetermined timeframe.

18. The method according to claim 12, wherein the movement data is determined from the chronological pattern of the location positions of the communication devices determined via radio positioning.

19. The method according to claim 12, wherein the movement data regarding the acceleration and braking maneuvers is determined by acceleration sensors integrated in the respective communication device or connected to said device using signal technology.

20. The method according to claim 12, wherein when a pattern characteristic for a speed monitoring device according to ii) is detected, the driver is notified of the assumed presence of the speed monitoring device by the communication device, and the driver is prompted to confirm this, whereupon when the confirmation is received, the information is transmitted to the central data collection point.

21. A traffic guidance system having the following:
i) a plurality of communication devices set up for radio positioning and for route guidance that are used individually in a vehicle to which they are assigned;
ii) a central data collection point that is set up for receiving data transmitted by means of the communication devices;
iii) a data transmitter that is connected to the data collection point and is set up to transmit traffic guidance data to the communication devices;
wherein the communication devices are set up to record time and location data regarding driving speed as well as acceleration and braking maneuvers for the respective vehicle to which they are assigned;
wherein the communication devices are set up to evaluate the recorded data with respect to an occurrence of a following characteristic pattern in the braking and/or acceleration maneuvers and for a resulting determination of the presence of a speed monitoring device at a specific location:
starting from a first driving speed, a braking maneuver is recorded that leads to abrupt deceleration of the vehicle, in which the first driving speed is significantly reduced, followed by an acceleration maneuver until a second speed is reached that is less than the first driving speed;
wherein the communication devices are set up to transfer signals representing the speed monitoring device and the location of its occurrence to the central data collection point; and
wherein the data collection point is set up to evaluate the speed monitoring device as being reliably determined when the data transferred by a predetermined number of communication devices enables the detection of such a device at a location, and
wherein the data transmitter is set up to transmit information to the communication devices regarding the location of the speed monitoring device determined to be reliable as traffic data.
